(19) United States
(12) Patent Application Publication
(10) Pub. No.: US 2002/0190960 A1
(43) Pub. Date: Dec. 19, 2002

(54) Method for controlling computer cursor based on identification of user fingerprint

(76) Inventors: Shyh-Ren Kuo, Taipei (TW); Tzong-Yu Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/881,098

(22) Filed: Jun. 15, 2001

(51) Int. Cl. G09G 5/00

(52) U.S. Cl. 345/173

(57) ABSTRACT

A method for controlling access to and operation of a screen cursor of a computer based on the identification of a user's fingerprint is disclosed. The method includes the steps of (a) establishing a database of fingerprints of authorized users of the computer in advance; (b) reading a fingerprint of a finger of a user who attempts to access the computer by positioning and moving the finger on a mouse pad in connection with the computer; (c) identifying the fingerprint with the database; (d) denying the access to the computer if the fingerprint cannot be recognized; (e) calculating displacement of the finger on the touch pad and converting the displacement into a corresponding distance on the screen; and (f) moving the screen cursor through the distance on the screen. In the method, the touch pad functions to read the fingerprint and determine the displacement of the finger whereby the security and operability of the computer can be enhanced without additional devices.

### FIELD OF THE INVENTION

The present invention generally relates to a method for controlling a screen cursor of a computer, and in particular to a method for controlling the access to and the operation of a computer screen cursor based on the identification of a user's fingerprint in order to enhance security and operability of the computer system.

### BACKGROUND OF THE INVENTION

A computer mouse, together with a screen cursor, is a handy and efficient input means for a computer system. Most personal computers are equipped with a mouse for efficiently and effectively controlling the screen cursor and thus the operation of the computers. Although a computer system itself may be incorporated with some kind of security systems in order to prevent unauthorized operation thereof, a computer mouse is in general not secured. Thus, no means for preventing unauthorized use of a computer mouse to access a computer system is not available currently.

Besides the computer mice, another handy way for controlling a computer via a screen cursor is a touch pad or mouse pad. The touch pad or mouse pad is a small panel sensitive to “touch” of a user's finger whereby by sliding the finger on the panel, a screen cursor correspondingly moves on a display screen. The touch pad is in general integrated with for example a notebook computer. This simplifies the overall arrangement of the peripheral devices of a computer system. Similar to the computer mice, the touch pad or mouse pad is in general not protected from unauthorized operation.

It is desired to provide a method for preventing unauthorized use of a mouse pad to access a computer in order to enhance security of a computer system while maintaining easy operability of the computer.

### SUMMARY OF THE INVENTION

Accordingly, an object of the present invention is to provide a method for controlling a screen cursor and allowing activation of a mouse pad based on identification of a user's fingerprint.

Another object of the present invention is to provide a method for protecting a computer mouse pad from unauthorized use and improper access of a screen cursor for operating the computer.

In accordance with the present invention, a fingerprint identification system is incorporated in a computer system whereby a user is not allowed to operate the computer system by operating a screen cursor via a mouse pad. When the user's fingerprint is identified by the fingerprint identification system, the mouse pad is activated and the user may access the computer system via the mouse pad controlling the screen cursor. The mouse pad functions to both read the user's fingerprint and control the screen cursor whereby operability of screen cursor and system security can be realized with a single device.

### BRIEF DESCRIPTION OF THE DRAWING

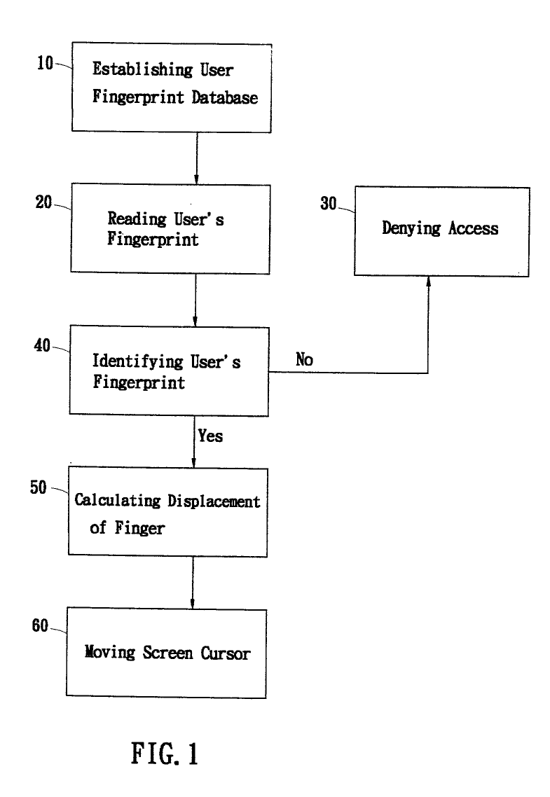

The present invention will be apparent to those skilled in the art by reading the following description of a preferred embodiment thereof, with reference to the sole drawing, FIG. 1, which is a flow chart of the method of the present invention.

### DETAILED DESCRIPTION OF THE PREFERRED EMBODIMENT

In the following, a best mode for carrying out a method for controlling computer cursor based on identification of user fingerprint in accordance with the present invention will be described in detail with reference to the flow chart shown in FIG. 1. The method of the present invention is based on the identification of user's fingerprint to allow the user's control of a computer cursor. After the user is identified by means of the fingerprint, the displacement of the user's finger on a sensing device, such as mouse pad, in connection with the computer is converted into a corresponding distance through which the computer cursor is to be moved on a display screen.

As shown in FIG. 1, the sole drawing of the present invention, a flow chart of the method of the present invention is illustrated. The method of the present invention comprises the following steps:

A database of the fingerprints of legal users of a computer system is established in the computer system in advance (step 10).

A user attempting to access the computer system places his or her finger on a fingerprint reading device in connection with the computer system. The computer system reads the fingerprint via the fingerprint reading device (step 20). In an embodiment of the present invention, the mouse pad serves as the fingerprint reading device.

The fingerprint is identified by comparison with the previously established database (step 40). If the fingerprint cannot be recognized, then the attempt to access the computer system is denied (step 30). If the fingerprint is confirmed by the computer system, then the computer system calculates the displacement of the finger on the touch pad (step 50). Thereafter, the displacement of the finger is converted to a corresponding distance through which the screen cursor is to be moved and then the cursor is moved accordingly (step 60).

In accordance with an embodiment of the present invention, the mouse pad serves as both a fingerprint reading device and a cursor displacement control device. A user may simply place and slide his or her finger on the mouse pad. The computer automatically checks the fingerprint and moves the cursor if the fingerprint is recognized.

By means of the previously establish database of user fingerprints, an attempt of unauthorized access of the computer system via the mouse pad can be effectively prevented. Computer security can be enhanced.

By means of the same finger of which the fingerprint is identified moving on the mouse pad, the user can readily control the operation of the computer system without an additional mouse or similar devices. Thus both security and operability of a computer can be achieved at the same time without additional devices.

Although the present invention has been described with reference to the best mode of operation thereof, it is apparent to those skilled in the art that a variety of modifications and changes may be made without departing from the scope of the present invention which is intended to be defined by the appended claims.

What is claimed is:

1. A method for controlling a screen cursor of a computer comprising the following steps:
(a) establishing a database of fingerprints of authorized users of the computer in advance;
(b) reading a fingerprint of a finger of a user who attempts to access the computer by positioning and moving the finger on a sensing device in connection with the computer;
(c) identifying the fingerprint with the database;
(d) denying the access to the computer if the fingerprint cannot be recognized;
(e) calculating displacement of the finger and converting the displacement into a corresponding distance on the screen; and
(f) moving the screen cursor through the distance on the screen.

2. The method as claimed in claim 1, wherein the sensing device comprises a mouse pad.

3. The method as claimed in claim 1, wherein the sensing device functions to read the fingerprint and determines the displacement of the finger.
